(19) United States
(12) Patent Application Publication
(10) Pub. No.: US 2026/0285764 A1
(43) Pub. Date: Sep. 24, 2026

(54) MULTILAYER CERAMIC ELECTRONIC DEVICE

(71) Applicant: TDK Corporation, Tokyo (JP)

(72) Inventors: Ryota NAMIKI, Tokyo (JP); Toshihiro IGUCHI, Tokyo (JP); Taku MURAKAMI, Tokyo (JP); Yasuhiro ITO, Tokyo (JP)

(73) Assignee: TDK Corporation, Tokyo (JP)

(21) Appl. No.: 19/567,920

(22) Filed: Mar. 16, 2026

(30) Foreign Application Priority Data
Mar. 19, 2025 (JP) 2025-045501

(51) Int. Cl. C04B 35/48; B32B 15/04; C04B 37/00

(52) U.S. Cl. CPC C04B 35/48; B32B 15/04; C04B 37/001; B32B 2250/02; B32B 2311/22; B32B 2457/00; C04B 2235/3217; C04B 2235/3248; C04B 2235/3249; C04B 2235/3262; C04B 2235/3418; C04B 2235/768; C04B 2237/348; C04B 2237/68

(57) ABSTRACT

A multilayer ceramic electronic device includes an element body including a dielectric layer and an inner electrode layer laminated on the dielectric layer. The dielectric layer includes main phase grains. The element body includes a segregation. The main phase grains contain a perovskite-type compound expressed by the composition formula of (Ca₁₋ₓ₋ₚSrₓBaₚ)ₘ(Zr_{1-y-z}Ti_{y}Hf_{z})O₃ as a main component based on the number of atoms. The values x, p, m, y, and z are within a predetermined range. The main phase grains further contain an oxide of Z. Z includes at least one selected from the group consisting of V, Nb, Ta, and W. The segregation contains at least L, Mn, Si, and O. L includes at least one selected from the group consisting of Ca and Sr. A content ratio of Z in the main phase grains is larger than a content ratio of Z in the segregation.

### TECHNICAL FIELD

The present disclosure relates to a multilayer ceramic electronic device.

### BACKGROUND

Patent Document 1 discloses a reduction-resistant dielectric ceramic composition, and a multilayer ceramic capacitor formed by alternately laminating ceramic sheets formed from the reduction-resistant dielectric ceramic composition and electrodes.

### Patent Document

Patent Document 1: JP Patent Application Laid Open No. 2007-091588

### SUMMARY

A multilayer ceramic electronic device according to an aspect of the present disclosure including:
an element body including a dielectric layer and an inner electrode layer laminated on the dielectric layer,
wherein the dielectric layer includes main phase grains,
the element body includes a segregation,
the main phase grains contain a perovskite-type compound expressed by a composition formula of (Ca₁₋ₓ₋ₚSrₓBaₚ)ₘ(Zr_{1-y-z}Ti_{y}Hf_{z})O₃ as a main component based on the number of atoms,
relationships of 0≤x≤1.0, 0≤p<1.0, 0.9≤m≤1.1, 0≤y≤0.20, and 0≤z<1.0 are satisfied,
the main phase grains further contain an oxide of Z,
Z includes at least one selected from the group consisting of V, Nb, Ta, and W,
the segregation contains at least L, Mn, Si, and O,
L includes at least one selected from the group consisting of Ca and Sr, and
a content ratio of Z in the main phase grains is larger than a content ratio of Z in the segregation.

### BRIEF DESCRIPTION OF THE DRAWINGS

FIG. 1 is a schematic view illustrating a cross-section of a multilayer ceramic capacitor according to an embodiment of the present disclosure;

FIG. 2 is a STEM image illustrating a segregation located inside a dielectric layer;

FIG. 3 is a STEM image illustrating a segregation located at a boundary between the dielectric layer and an inner electrode layer; and

FIG. 4 is a STEM image illustrating a segregation located at the inner electrode layer.

### DETAILED DESCRIPTION

An object of the present disclosure is to provide a multilayer ceramic electronic device having excellent reliability while maintaining satisfactory high-temperature resistivity.

In the multilayer ceramic electronic device according to the present disclosure, relationships of 0≤x<0.80, 0≤p<0.40, 0.9<m<1.1, 0≤y≤0.10, and 0≤z<0.20 may be satisfied.

In the multilayer ceramic electronic device according to the present disclosure, relationships of 0≤x<0.40, p=0, 0.9<m<1.1, 0.01<y≤0.10, and 0≤z<0.20 may be satisfied.

In the multilayer ceramic electronic device according to the present disclosure, a relationship of 1.5<Zm/Zs<7.5 may be satisfied where a content ratio of Z contained in the main phase grains to the total content of all element contained in the main phase grains is set as Zm based on the number of atoms, and a content ratio of Z contained in the segregation to the total content of all element contained in the segregation is set as Zs based on the number of atoms.

In the multilayer ceramic electronic device according to the present disclosure, a value obtained by dividing a content of Z by the total content of Z and Si may be 0.0002 or more and less than 0.0080 based on the number of atoms in the segregation.

In the multilayer ceramic electronic device according to the present disclosure, a value obtained by dividing a content of Z by the total content of Z and Mn may be 0.003 or more and less than 0.080 based on the number of atoms in the segregation.

In the multilayer ceramic electronic device according to the present disclosure, a value obtained by dividing a content of Mn by the total content of Si and Mn may be 0.02 or more and less than 0.50 based on the number of atoms in the segregation.

In the multilayer ceramic electronic device according to the present disclosure, a value obtained by dividing a content of Z by the total content of Z and Ni may be more than 0 and less than 0.060 based on the number of atoms in the segregation.

In the multilayer ceramic electronic device according to the present disclosure, a value obtained by dividing the total content of Ca and Sr by the total content of Zr and Ti may be 1.0 or more and 8.0 or less based on the number of atoms in the segregation.

In the multilayer ceramic electronic device according to the present disclosure, the segregation may contain oxides of at least one selected from the group consisting of Al, Mg, Li, B, and P.

In the multilayer ceramic electronic device according to the present disclosure, a main component of a conductive material contained in the inner electrode layer may be Ni or a Ni-based alloy.

Hereinafter, the present disclosure will be described based on specific embodiments.

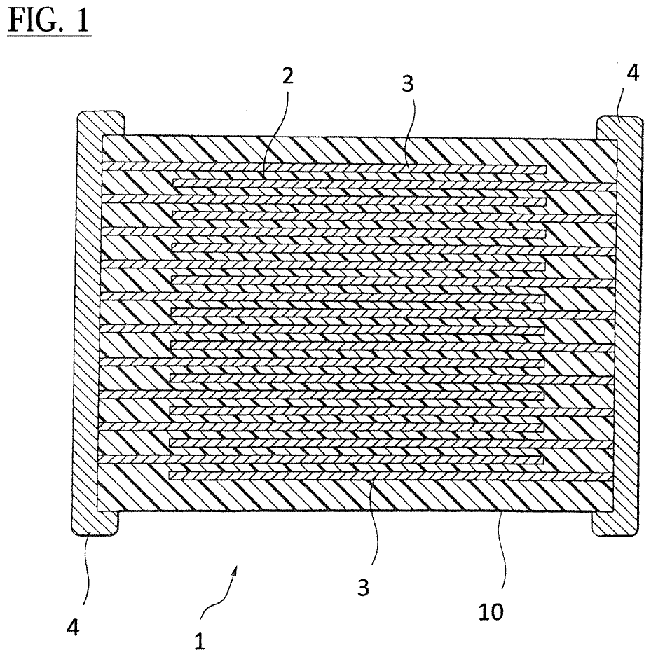

As an example of an electronic device according to the present embodiment, a multilayer ceramic capacitor 1 is illustrated in FIG. 1. The multilayer ceramic capacitor 1 includes an element body 10 having a configuration in which dielectric layers 2 and inner electrode layers 3 are laminated alternately. A pair of outer electrodes 4, which are electrically connected to the inner electrode layers 3 disposed alternately at the inside of the element body 10, are formed at both ends of the element body 10. The shape of the element body 10 is not particularly limited, but the shape is typically set to a rectangular parallelepiped shape. In addition, the dimensions of the element body 10 are also not particularly limited, and may be set to appropriate dimensions depending on applications.

The dielectric layers 2 contain main phase grains to be described later. The thickness (interlayer thickness) of each of the dielectric layers 2 is not particularly limited, and can be arbitrarily set depending on desired characteristics, applications, and the like. Typically, the interlayer thickness may be 30 μm or less, or may be 10 μm or less. In addition, the number of the laminated dielectric layers 2 is not particularly limited, but in the present embodiment, the laminating number may be, for example, 20 or more.

The inner electrode layers 3 are laminated such that respective cross-sections are alternately exposed to surfaces of the two facing ends of the element body 10.

A main component of a conductive material contained in each of the inner electrode layers 3 is a metal. The metal is not particularly limited, and for example, a conductive material known as a metal such as Pd, a Pd-based alloy, Pt, a Pt-based alloy, Ni, a Ni-based alloy, Cu, or a Cu-based alloy may be used. The metal that is a main component of the conductive material may be Ni or a Ni-based alloy. The metal may contain various minor components such as P, S, and Cl, each in an amount of approximately 0.1% by mass or less. The inner electrode layer 3 may be formed by using a commercially available electrode paste. The thickness of the inner electrode layer 3 may be appropriately determined depending on the intended application.

A conductive material contained in the outer electrodes 4 is not particularly limited. For example, a known conductive material such as Ni, Cu, Sn, Ag, Pd, Pt, Au, alloys of the elements, or a conductive resin may be used. The thickness of each of the outer electrodes 4 may be appropriately determined depending on the intended application.

The main phase grains contained in the dielectric layers 2 contains a perovskite-type compound expressed by a composition formula of (Ca₁₋ₓ₋ₚSrₓBaₚ)ₘ(Zr_{1-y-z}Ti_{y}Hf_{z})O₃ as a main component based on the number of atoms. Then, relationships of 0≤x≤1.00, 0≤p<1.00, 0.9≤m≤1.1, 0≤y≤0.20, and 0≤z<1.00 are satisfied.

Relationships of 0≤x<0.80, 0≤p<0.40, 0.9<m<1.1, 0≤y≤0.10, and 0≤z<0.20 may be satisfied.

Relationships of 0≤x<0.40, p=0, 0.9<m<1.1, 0.01<y≤0.10, and 0≤z<0.20 may be satisfied.

Furthermore, a relationship of 0.01<y≤0.07 may be satisfied. In addition, a relationship of 0≤z≤0.01 may be satisfied.

The perovskite-type compound is a compound having a perovskite-type crystal structure represented by the general formula ABO₃ (A is an A-site element and B is a B-site element).

As described above, the perovskite-type compound according to the present embodiment contains at least Ca and/or Sr as the A-site element. The perovskite-type compound contains at least Zr and/or Ti as the B-site element. The perovskite-type compound may further contain Ba as the A-site element, and may further contain Hf as the B-site element.

The main phase grains further contain an oxide of an additive element in addition to the perovskite-type compound. The oxide of the additive element includes at least an oxide of Z. Z includes at least one selected from the group consisting of V, Nb, Ta, and W. The main phase grains further contain L, Mn, Si, and O. L includes at least one selected from the group consisting of Ca and Sr. The main phase grains may contain an oxide of L, an oxide of Mn, and an oxide of Si.

The element body 10 includes the dielectric layers 2 and the inner electrode layers 3, and the element body 10 further includes a segregation 12.

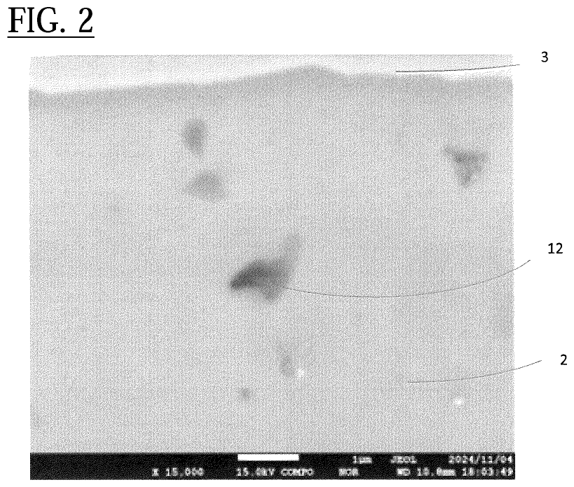

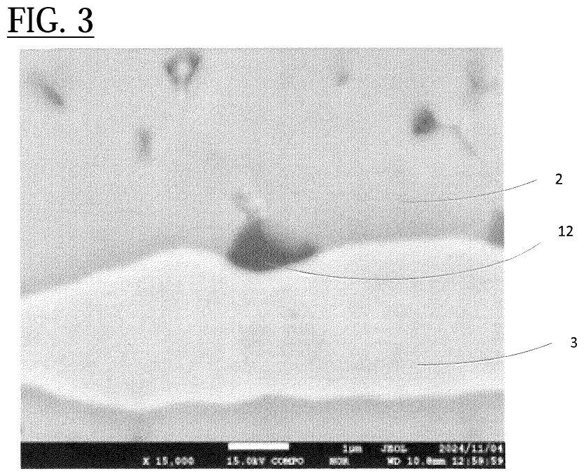

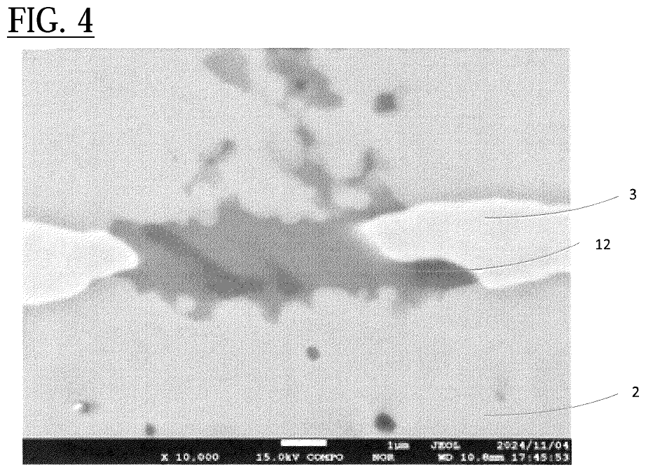

The position of the segregation 12 in the element body 10 is not particularly limited. FIGS. 2 to 4 are STEM images obtained by observing a cross-section obtained by cutting the element body 10 along a laminating direction using STEM. As illustrated in FIG. 2, the segregation 12 may be located inside the dielectric layers 2. As illustrated in FIG. 3, the segregation 12 may be located at a boundary between each of the dielectric layers 2 and each of the inner electrode layers 3. As illustrated in FIG. 4, the segregation 12 may be located in the inner electrode layer 3. That is, the segregation 12 may be located in a portion where the inner electrode is discontinued in the cross-section.

An area of the segregation 12 is set to 1 μm² or more. That is, a portion of which an area is less than 1 μm² is not regarded as the segregation 12.

Then, a content ratio of Z in the main phase grains is larger than a content ratio of Z in the segregation 12. That is, when a content ratio of Z contained in the main phase grains to the total content of all element contained in the main phase grains is set as Zm based on the number of atoms, and when a content ratio of Z contained in the segregation 12 to the total content of all element contained in the segregation 12 is set as Zs based on the number of atoms, a relationship of Zm/Zs>1.0 may be satisfied, or a relationship of Zm/Zs≥1.1 may be satisfied. In addition, a relationship of 1.5<Zm/Zs<7.5 may be satisfied. According to this configuration, the reliability can be improved while maintaining the high-temperature resistivity in a satisfactory manner.

When measuring the content ratio of Z in the main phase grains, at least 10 measurement sites are set in the main phase grains, and content ratios of Z calculated at the measurement sites may be averaged. In addition, when measuring the content ratio of Z in the segregation 12, at least 10 measurement sites are set in a central portion of the segregation 12 (a portion where a distance from an outer periphery of the segregation 12 is 0.5 μm or more), and content ratios of Z calculated at the measurement sites may be averaged.

In the segregation 12, a value obtained by dividing the content of Z by the total content of Z and Si may be 0.0002 or more and less than 0.0080 based on the number of atoms.

In the segregation 12, a value obtained by dividing the content of Z by the total content of Z and Mn may be 0.003 or more and less than 0.080 based on the number of atoms.

In the segregation 12, a value obtained by dividing the content of Mn by the total content of Si and Mn may be 0.02 or more and less than 0.50 based on the number of atoms.

In the segregation 12, a value obtained by dividing the content of Z by the total content of Z and Ni may be more than 0 and less than 0.060 based on the number of atoms.

In the segregation 12, a value obtained by dividing the total content of Ca and Sr by the total content of Zr and Ti may be 1.0 or more and 8.0 or less based on the number of atoms.

In a case where the segregation 12 has a composition within the above-described ranges, the high-temperature resistivity and the reliability are further likely to be improved.

Furthermore, the segregation 12 may contain oxides of at least one selected from the group consisting of Al, Mg, Li, B, and P. In a case of containing oxides of at least one selected from the group consisting of the elements, the temperature characteristics are likely to be improved.

In addition, when comparing the content of Z between a case where the segregation 12 is located in the dielectric layer as illustrated in FIG. 2, and a case where the segregation 12 is in contact with the inner electrode layer 3 or located in the inner electrode layer 3 as illustrated in FIGS. 3 and 4, in the segregation 12 located in the dielectric layer, the content of Z is likely to be increased. In the segregation 12 located in the dielectric layer, Z may be contained in a ratio of the number of 60% or more and 100% or less, or 90% or more and 100% or less. In the segregation 12 that is in contact with the inner electrode layer 3 or located in the inner electrode layer 3, Z may be contained in a ratio of the number of 0% or more and 50% or less, or 0% or more and 20% or less.

Hereinafter, an example of a method for manufacturing the multilayer ceramic capacitor 1 illustrated in FIG. 1 will be described.

First, a process of manufacturing the element body 10 will be described. In the process of manufacturing the element body 10, a dielectric paste that becomes the dielectric layer 2 after firing, and an inner electrode paste that becomes the inner electrode layer 3 after firing are prepared.

The method for producing the dielectric paste is not particularly limited. For example, the dielectric paste is produced by the following method. First, a raw material powder (hereinafter, may be described as “main component raw material powder) of a main component of mainly the dielectric ceramic composition is prepared. A commercially available perovskite-type compound powder may be prepared as the raw material powder. In addition, the raw material powder may be prepared by preparing an oxide powder of the A-site element and an oxide powder of the B-site element of the perovskite-type compound, dispersing the powders in a solvent (for example, pure water), drying the resultant solution, and performing a heat treatment. The holding temperature in the heat treatment for preparing the raw material powder is not particularly limited. For example, the holding temperature may be 900° C. or higher and 1300° C. or lower. The holding time is not particularly limited. For example, the holding time may be 0.5 hours or longer and 5 hours or shorter.

In addition, oxide powders of additive elements may be simultaneously dispersed in the solvent in combination with the oxide powder of the A-site element and the oxide powder of the B-site element of the perovskite-type compound.

A powder of a compound that becomes an oxide of each element by sintering, for example, a powder of a carbonate of each element may be used instead of the oxide powder of each element. In addition, a powder of a composite compound of each element may be used.

A part of the oxide powders of the additive elements is added as sintering aids that contains at least Al₂O₃ and MnCO₃, and may contain SiO₂. The sintering aids are prepared by calcining a mixed powder obtained by mixing powders consisting of the compounds. The amount of the sintering aids added is not particularly limited, but 1 part by weight or more and 5 parts by weight or less of sintering aids may be added with respect to 100 parts by weight of perovskite-type compound powder.

The content of MnCO₃ in the mixed powder before the calcination may be 55% by weight or more and 75% by weight or less, the content of Al₂O₃ may be 0% by weight or more and 15% by weight or less, and the content of SiO₂ may be 15% by weight or more and 40% by weight or less. With regard to calcination conditions, for example, a firing temperature may be 800° C. or higher and 1200° C. or lower, and the holding time may be 1 hour or longer and 5 hours or shorter.

Next, the main component raw material powder, and a raw material powder of an oxide of Z are mixed and calcined to obtain a calcined powder. Calcination conditions are not particularly limited, but the holding temperature may be set to 800° C. to 1200° C. The holding time may be set to 1 to 5 hours.

Next, raw material powders other than the main component raw material powder and the raw material powder of the oxide of Z are mixed with the calcined powder, and the resultant mixture is dispersed in pure water, the resultant solution is dried and subjected to a heat treatment, thereby obtaining a dielectric powder. The holding temperature during the heat treatment may be set to 100° C. to 300° C. The holding time during the heat treatment may be set to 0.5 to 5 hours.

When obtaining the calcined powder by mixing the main component raw material powder, and the raw material powder of the oxide of Z and calcining the resultant mixture, the oxide of Z is likely to be contained in the main phase grains. On the other hand, in a case where the calcined powder is not prepared, the oxide of Z is likely to be contained in the segregation. Particularly, in a case of obtaining the calcined powder by mixing the raw material powder of the oxide of Z with a raw material powder other than the main component raw material powder of the sintering aids or the like, the oxide of Z is particularly likely to be contained in the segregation. Accordingly, Zm/Zs can be controlled by changing a ratio of the raw material powder of the oxide of Z that is mixed with the main component raw material powder and is calcined to obtain the calcined powder.

Then, the obtained dielectric powder, a binder, and a solvent (an organic solvent or water) are kneaded to produce a dielectric paste. The kinds of the binder and the solvent are not particularly limited. An organic vehicle that is obtained by mixing the binder and the organic solvent may be used instead of the binder and the solvent. The dielectric paste may contain an additive such as a plasticizer and a dispersant as necessary.

The inner electrode paste is obtained by kneading a raw material of the conductive material, a binder, and a solvent (an organic solvent or water). The kinds of the binder and the solvent are not particularly limited. The inner electrode paste may contain additives such as sintering inhibitors and plasticizers as necessary.

A green sheet and an inner electrode pattern are formed by the obtained respective pastes, and are laminated to obtain a green chip.

A binder removal treatment may be performed on the obtained green chip as necessary. Binder removal treatment conditions may be known condition. For example, the holding temperature may be set to 180° C. or higher and 400° C. or lower, and the holding time may be set to 0.5 hours or longer and 24 hours or shorter. In addition, an atmosphere during the binder removal treatment is also not particularly limited. In addition, the holding temperature under a reducing atmosphere may be set to 1100° C. or lower.

After the binder removal treatment, the green chip is fired to obtain the element body 10. In the present embodiment, an atmosphere during firing may be set to a reducing atmosphere with an oxygen partial pressure of 2.0×10⁻¹³ atm or more and 1.0×10⁻⁷ atm or less. The other firing conditions may be set to known conditions. For example, the holding temperature may be set to 1200° C. or higher and 1400° C. or lower, and the holding time may be set to 0.5 hours or longer and 8 hours or shorter.

After the firing, an annealing treatment may be performed as necessary. Annealing treatment conditions are not particularly limited. For example, the holding temperature may be set to 500° C. or higher and 1150° C. or lower, and the holding time may be set to 0.5 hours or longer and 20 hours or shorter. An oxygen partial pressure in an annealing atmosphere may be set to, for example, 1.0×10⁻⁹ atm or more and 3.0×10⁻⁵ atm or less.

The dielectric ceramic composition constituting the dielectric layer 2 of the element body 10, which is obtained as described above, is the above-described dielectric ceramic composition. An end surface of the element body 10 is polished as necessary, and an outer electrode paste is applied and baked to form the outer electrodes 4. Then, a coating layer is formed on a surface of the outer electrodes 4 by plating or the like as necessary. The method for preparing the outer electrode paste is not particularly limited, and the outer electrode paste may be prepared by a similar method as in the inner electrode paste.

As described above, the multilayer ceramic capacitor 1 according to the present embodiment is manufactured.

Hereinbefore, the embodiment of the present disclosure has been described, but the present disclosure is not limited to the above-described embodiment, and various modifications can be made within a range not departing from the gist of the present disclosure.

### EXAMPLES

Hereinafter, the present disclosure will be described with reference to more detailed examples, but the present disclosure is not limited to the examples.

### Experimental Example 1

In Experimental Example 1, the multilayer ceramic capacitor 1 illustrated in FIG. 1 was manufactured in the following procedure.

First, the dielectric paste was prepared.

A raw material powder (hereinafter, may be described as a main component raw material powder) of the perovskite-type compound contained as a main component of the main phase grains was prepared. Specifically, a raw material powder of a Ca oxide, a raw material powder of a Sr oxide, a raw material powder of a Ba oxide, a raw material powder of a Zr oxide, and a raw material powder of a Ti oxide, and a raw material powder of a Hf oxide were prepared and weighed to obtain perovskite-type compounds having dielectric compositions shown in Table 1. The term “a raw material powder of a y oxide” represents a powder of the y oxide and/or a powder of a compound that becomes the y oxide by heat treatment. Then, respective powders were dispersed in pure water, and the resultant dispersed solution was dried and subjected to a heat treatment (the holding temperature was 1150° C. to 1250° C., and the holding time was 0.5 to 5 hours) to prepare a main component raw material powder.

Additionally, sintering aids were prepared. 65.5% by weight of MnCO₃ powder and 34.5% by weight of SiO₂ powder were mixed and calcined. With regard to calcination conditions, a firing temperature was set to 1000° C. and the holding time was set to 2 hours.

Additionally, the sintering aids and powders of oxides of additive elements (a raw material powder of a Mn oxide, a SiO₂ powder, a raw material powder of a Ca oxide, a raw material powder of a Zr oxide, a NiO powder, and/or a raw material powder of an oxide of Z (W)) were prepared and weighed. In all examples, 1 to 5 parts by weight of the sintering aids was contained with respect to 100 parts by weight of the content of the main component raw material powder. However, in a case of using 1 part by weight of sintering aids, when the content of any element of Mn and Si is excessively large, the amount of the sintering aids used was increased as much as possible within a range of less than 1 part by weight.

The amounts of respective raw material powders added were controlled such that in the finally obtained dielectric ceramic composition, Zm/Zs becomes 3.5 or more and 5.0 or less, Z/(Z+Si) in the segregation becomes 0.0035 or more and 0.0050 or less, Z/(Z+Mn) in the segregation becomes 0.020 or more and 0.035 or less, Mn/(Mn+Si) in the segregation becomes 0.20 or more and 0.35 or less, Z/(Z+Ni) in the segregation becomes 0.020 or more and 0.030 or less, and (Ca+Sr)/(Zr+Ti) in the segregation becomes 4.0 or more and 5.0 or less. For example, in Sample No. 3, with respect to 100 parts by weight of the content of the main component raw material powder, the sintering aids was set to 2.0 parts by weight, the raw material powder (WO₃ powder) of an oxide of W was set to 0.3 parts by weight, a raw material powder (MnO powder) of an oxide of Mn was set to 0.1 parts by weight, a raw material powder of SiO₂ was set to 3.0 parts by weight, a raw material powder (CaO powder) of a Ca oxide was set to 0.4 parts by weight, a raw material powder (ZrO₂ powder) of a Zr oxide was set to 0.1 parts by weight, and a raw material powder of NiO was set to 0.9 parts by weight.

In Experimental Example 1, the main component raw material powder, and the raw material powder of the oxide of Z were mixed and calcined to obtain a calcined powder. With regard to calcination conditions, the holding temperature was set to 1000° C. and the holding time was set to 2 hours. In Sample No. 7, only the main component raw material powder was mixed and calcined to obtain a calcined powder.

Next, raw material powders other than the main component raw material powder and the raw material powder of the oxide of Z were mixed with the calcined powder, and the resultant mixture was dispersed in pure water, the resultant solution was dried and subjected to a heat treatment, thereby obtaining a dielectric powder. The holding temperature was set to 400° C., and the holding time was set to 2.0 hours.

As described above, a preparation method in which the main component raw material powder and the raw material powder of the oxide of Z are mixed and calcined to obtain a calcined powder, and then the calcined powder and other raw materials such as the sintering aids are mixed is referred to as Preparation Method 1.

The dielectric powder and an organic vehicle were kneaded to prepare a dielectric paste. 100 parts by mass of the dielectric powder, 10 parts by mass of polyvinyl butyral resin, 5 parts by mass of dioctyl phthalate (DOP) as a plasticizer, and 100 parts by mass of alcohol as a solvent were mixed with a ball mill to be a paste, thereby obtaining the dielectric paste.

The method for preparing the inner electrode paste is as follows. First, a Ni powder, terpineol, ethyl cellulose, and benzotriazole were prepared in a mass ratio of 44.6:52.0:3.0:0.4. Then, these were kneaded by three rolls to be paste, thereby preparing the inner electrode paste.

Next, a green chip was manufactured with a sheet method by using the above-described dielectric paste and the inner electrode paste. Then, the green chip was subjected to a binder removal treatment, a firing treatment, and an annealing treatment to obtain a rectangular parallelepiped element body 10 having dimensions of 3.2 mm×1.6 mm×0.7 mm. With regard to the dimensions, a dimension in a horizontal direction in FIG. 1 is 3.2 mm, and a dimension in a vertical direction (laminating direction) in FIG. 1 is 0.7 mm. In the firing treatment, the holding temperature during the firing treatment was set to 1200° C. to 1300° C., the holding time was set to 2.0 hours, an atmosphere during the firing was set to a reducing atmosphere with an oxygen partial pressure of 2.0×10⁻¹³ atm or more and 1.0×10⁻⁷ atm or less. In addition, in the obtained element body 10, the number of the laminated dielectric layers 2 each being sandwiched between the inner electrode layers 3 was set to 10, an average thickness of the dielectric layers 2 each being sandwiched between the inner electrode layer 3 was set to 5.0 μm, and an average thickness of the inner electrode layers 3 was set to 1.2 μm.

With regard to the holding temperature during the firing, a preliminary test was performed on respective samples at six holding temperatures: 1200° C., 1220° C., 1240° C., 1260° C., 1280° C., and 1300° C. Then, the lowest holding temperature among holding temperatures at which the element body 10 was densified was adopted. Whether the element body 10 was densified was determined by observing a cross-section of the element body 10 using STEM. Specifically, it was determined whether or not an area of voids in a field of view of 450 μm² or more in a cross-section of the element body 10 was 2% or less of an area of the dielectric layers 2 in the field of view.

Next, a baked electrode layer containing Cu, a Ni plated layer, and a Sn plated layer are sequentially formed in this order on an outer surface of the above-described element body 10 to form the outer electrode 4, thereby obtaining the multilayer ceramic capacitor 1.

### (Composition of Dielectric Ceramic Composition)

With regard to a composition of the dielectric ceramic composition, composition analysis was performed on the dielectric layers 2 using ICP emission spectroscopy. The dielectric composition and the content ratios of the additive elements were substantially the same between the batch composition and the composition of the dielectric ceramic composition.

### (Zm/Zs and Segregation Composition)

A cross-section of the dielectric layers 2 included in the multilayer ceramic capacitor 1 was observed using STEM-EDS. An observation magnification was set to 20000 times, and an observation range was set to 7 μm×7 μm. Then, the main phase grains and the segregation were distinguished.

Next, measurement sites of 10 or more points were set for the main phase grains contained in the observation range, and measurement sites of 10 or more points were set for a central portion of the segregation 12 included in the observation range, point analysis was performed for the measurement sites using STEM-EDS to measure a composition of each measurement site. Content ratios (Zm) of Z were measured for all measurement sites included in the main phase grains, and an average value of Zm was calculated. Content ratios (Zs) of Z were measured for all measurement sites included in the segregation, and were averaged to calculate an average value of Zs. Then, Zm/Zs was calculated by dividing the average value of Zm by the average value of Zs. The results are shown in Table 1.

The content of Z, the content of Si, the content of Mn, the content of Ni, the content of Ca, the content of Sr, the content of Zr, and the content of Ti at all measurement sites included in the segregation were measured. Z/(Z+Si), Z/(Z+Mn), Z/(Z+Ni), Mn/(Mn+Si), and (Ca+Sr)/(Zr+Ti) were calculated from an average value of the content of Z, an average value of the content of Si, an average value of the content of Mn, an average value of the content of Ni, an average value of the content of Ca, an average value of the content of Sr, an average value of the content of Zr, and an average value of the content of Ti. The results are shown in Table 1.

### (High-Temperature Resistivity Test)

Insulation resistance of the multilayer ceramic capacitor 1 at a high temperature and a high electric field was evaluated. Specifically, insulation resistance when a DC voltage of 500 V (100 V/μm) was applied at 180° C. was measured. The results are shown in Table 1. In a case where the insulation resistance at the high temperature and the high electric field was 1.0×10¹²Ω or more, the high-temperature resistivity was evaluated as being satisfactory.

### (Reliability Test)

High-temperature load life of the multilayer ceramic capacitor 1 was evaluated. Specifically, the multilayer ceramic capacitor 1 was held at 200° C. in a state of being applied with a DC voltage of 800 V (160V/μm) to measure the service life. In the present examples, the service life was defined as the shortest time between time from the start of application until insulation resistance dropped by one digit and time from the start of application until a sample failed. In the present examples, the above-described evaluation was performed on twenty multilayer ceramic capacitors 1, and a mean time to failure (MTTF) was calculated of the service life of each of the multilayer ceramic capacitor 1. In a case where MTTF was 2.00×10² hours or longer and shorter than 1.00×10³ hours, reliability was evaluated as satisfactory, and in a case where MTTF was 1.00×10³ hours or longer, the reliability was evaluated as particularly satisfactory. The results are shown in Table 1.

In Table 1, some experiment results are expressed as rE+s, which represents r×10^{s}.

TABLE 1

| | | | | Additive | | | Segregation |
|---|---|---|---|---|---|---|---|
| | | | | Elements | | | Z/(Z + Si) |
| Example/ | | | | Other Than | | | (ratio of |
| Comparative | Sample | Preparation | Perovskite-Type Compound | Z, Ca, Zr, | Type | | number |
| Example | No. | Method | (based on number of atoms) | and Ni | of Z | Zm/Zs | of atoms) |
| Example | 1 | Preparation | CaZrO₃ | Mn, Si | W | 4.4 | 0.0047 |
| | | Method 1 | | | | | |
| Example | 2 | Preparation | (Ca_{0.70}Sr_{0.30})(Zr_{0.90}Ti_{0.09}Hf_{0.01})O₃ | Mn, Si | W | 4.4 | 0.0043 |
| | | Method 1 | | | | | |
| Example | 3 | Preparation | (Ca_{0.70}Sr_{0.30})(Zr_{0.97}Ti_{0.03}Hf_{0.01})O₃ | Mn, Si | W | 4.2 | 0.0043 |
| | | Method 1 | | | | | |
| Example | 4 | Preparation | (Ca_{0.10}Sr_{0.65}Ba_{0.25})(Zr_{0.93}Ti_{0.06}Hf_{0.01})O₃ | Mn, Si | W | 4.4 | 0.0046 |
| | | Method 1 | | | | | |
| Comparative | 5 | Preparation | BaTiO₃ | Mn, Si | W | 4.3 | 0.0045 |
| Example | | Method 1 | | | | | |
| Comparative | 6 | Preparation | SrTiO₃ | Mn, Si | W | 4.0 | 0.0044 |
| Example | | Method 1 | | | | | |
| Comparative | 7 | — | (Ca_{0.70}Sr_{0.30})(Zr_{0.97}Ti_{0.03}Hf_{0.01})O₃ | Mn, Si | Not | Without Z | |
| Example | | | | | added | | |
| Comparative | 8 | Preparation | Ca(Zr_{0.60}Ti_{0.40})O₃ | Mn, Si | W | 4.1 | 0.0045 |
| Example | | Method 1 | | | | | |

| | | | | | Segregation | | |
|---|---|---|---|---|---|---|---|
| | | Segregation | Segregation | Segregation | (Ca + Sr)/ | | |
| | | Z/(Z + Mn) | Z/(Z + Ni) | Mn/(Mn + Si) | (Zr + Ti) | High- | |
| Example/ | | (ratio of | (ratio of | (ratio of | (ratio of | Temperature | |
| Comparative | Sample | number | number | number | number | Resistivity | MTTF |
| Example | No. | of atoms) | of atoms) | of atoms) | of atoms) | (Ω · m) | (h) |
| Example | 1 | 0.027 | 0.024 | 0.27 | 4.3 | 4.37E+12 | 1.20E+03 |
| Example | 2 | 0.023 | 0.024 | 0.31 | 4.3 | 4.10E+12 | 1.27E+03 |
| Example | 3 | 0.023 | 0.026 | 0.28 | 4.4 | 1.53E+12 | 1.33E+03 |
| Example | 4 | 0.024 | 0.027 | 0.28 | 4.3 | 1.20E+12 | 1.22E+03 |
| Comparative | 5 | 0.025 | 0.022 | 0.31 | 4.2 | 9.97E+08 | 2.70E+01 |
| Example | | | | | | | |
| Comparative | 6 | 0.024 | 0.025 | 0.30 | 4.3 | 2.57E+09 | 9.00E+01 |
| Example | | | | | | | |
| Comparative | 7 | Without Z | | 0.28 | 4.3 | 5.52E+10 | 1.22E+02 |
| Example | | | | | | | |
| Comparative | 8 | 0.024 | 0.023 | 0.29 | 4.2 | 3.35E+09 | 2.51E+02 |
| Example | | | | | | | |

As shown in Table 1, Sample Nos. 1 to 4, in which the composition of the perovskite-type compound contained in the main phase grains was within a predetermined range and Zm was larger than Zs (Zm/Zs>1.0), exhibited satisfactory high-temperature resistivity and reliability. In contrast, Sample Nos. 5, 6, and 8, in which the composition of the perovskite-type compound was outside the predetermined range, exhibited decreased high-temperature resistivity and reliability. Sample No. 7, in which Z was not contained, exhibited decreased high-temperature resistivity.

### Experimental Example 2

Sample No. 11 was obtained under the same conditions and the same experiment was performed as in Sample No. 3 of Experimental Example 1 except that 64.8% by weight of MnCO₃ powder, 7.5% by weight of Al₂O₃ powder, and 27.7% by weight of SiO₂ powder were mixed and calcined to obtain sintering aids.

Sample Nos. 12 to 19 were obtained by changing mainly the type of Z from Sample No. 3 of Experimental Example 1, and the same experiment was performed. In Sample No. 12, the ratio of W and Nb was 1:1 based on the number of atoms, and in Sample No. 13, the ratio of W and Ta was 1:1 based on the number of atoms. In Sample No. 17, Mo was contained instead of Z. In Sample No. 18, Y was contained instead of Z. In Sample No. 19, Dy was contained instead of Z. The results are shown in Table 2. Results of Sample No. 7 that was obtained under same conditions and subjected to the same experiment as in Sample No. 3 except that Z was not contained are shown in Table 2.

TABLE 2

| | | | | Additive | | | Segregation |
|---|---|---|---|---|---|---|---|
| | | | | Elements | | | Z/(Z + Si) |
| Example/ | | | | Other Than | | | (ratio of |
| Comparative | Sample | Preparation | Perovskite-Type Compound | Z, Ca, Zr, | Type | | number |
| Example | No. | Method | (based on number of atoms) | and Ni | of Z | Zm/Zs | of atoms) |
| Example | 11 | Preparation | (Ca_{0.70}Sr_{0.30})(Zr_{0.97}Ti_{0.03}Hf_{0.01})O₃ | Mn, Al, | W | 4.0 | 0.0046 |
| | | Method 1 | | Si | | | |
| Example | 3 | Preparation | (Ca_{0.70}Sr_{0.30})(Zr_{0.97}Ti_{0.03}Hf_{0.01})O₃ | Mn, Si | W | 4.0 | 0.0045 |
| | | Method 1 | | | | | |
| Example | 12 | Preparation | (Ca_{0.70}Sr_{0.30})(Zr_{0.97}Ti_{0.03}Hf_{0.01})O₃ | Mn, Si | W, Nb | 4.0 | 0.0044 |
| | | Method 1 | | | | | |
| Example | 13 | Preparation | (Ca_{0.70}Sr_{0.30})(Zr_{0.97}Ti_{0.03}Hf_{0.01})O₃ | Mn, Si | W, Ta | 4.3 | 0.0045 |
| | | Method 1 | | | | | |
| Example | 14 | Preparation | (Ca_{0.70}Sr_{0.30})(Zr_{0.97}Ti_{0.03}Hf_{0.01})O₃ | Mn, Si | Nb | 4.4 | 0.0046 |
| | | Method 1 | | | | | |
| Example | 15 | Preparation | (Ca_{0.70}Sr_{0.30})(Zr_{0.97}Ti_{0.03}Hf_{0.01})O₃ | Mn, Si | Ta | 4.4 | 0.0046 |
| | | Method 1 | | | | | |
| Example | 16 | Preparation | (Ca_{0.70}Sr_{0.30})(Zr_{0.97}Ti_{0.03}Hf_{0.01})O₃ | Mn, Si | V | 4.4 | 0.0044 |
| | | Method 1 | | | | | |
| Comparative | 17 | Preparation | (Ca_{0.70}Sr_{0.30})(Zr_{0.97}Ti_{0.03}Hf_{0.01})O₃ | Mn, Si | Not | Without Z | |
| Example | | Method 1 | | | added | (Mo added) | |
| Comparative | 18 | Preparation | (Ca_{0.70}Sr_{0.30})(Zr_{0.97}Ti_{0.03}Hf_{0.01})O₃ | Mn, Si | Not | Without Z | |
| Example | | Method 1 | | | added | (Y added) | |
| Comparative | 19 | Preparation | (Ca_{0.70}Sr_{0.30})(Zr_{0.97}Ti_{0.03}Hf_{0.01})O₃ | Mn, Si | Not | Without Z | |
| Example | | Method 1 | | | added | (Dy added) | |
| Comparative | 7 | Preparation | (Ca_{0.70}Sr_{0.30})(Zr_{0.97}Ti_{0.03}Hf_{0.01})O₃ | Mn, Si | Not | Without Z | |
| Example | | Method 1 | | | added | | |

| | | | | | Segregation | | |
|---|---|---|---|---|---|---|---|
| | | Segregation | Segregation | Segregation | (Ca + Sr)/ | | |
| | | Z/(Z + Mn) | Z/(Z + Ni) | Mn/(Mn + Si) | (Zr + Ti) | High- | |
| Example/ | | (ratio of | (ratio of | (ratio of | (ratio of | Temperature | |
| Comparative | Sample | number | number | number | number | Resistivity | MTTF |
| Example | No. | of atoms) | of atoms) | of atoms) | of atoms) | (Ω · m) | (h) |
| Example | 11 | 0.023 | 0.023 | 0.30 | 4.6 | 2.19E+12 | 1.34E+03 |
| Example | 3 | 0.022 | 0.023 | 0.30 | 4.2 | 5.00E+12 | 1.33E+03 |
| Example | 12 | 0.025 | 0.023 | 0.27 | 4.4 | 3.43E+12 | 1.33E+03 |
| Example | 13 | 0.026 | 0.022 | 0.30 | 4.4 | 4.87E+12 | 1.32E+03 |
| Example | 14 | 0.023 | 0.025 | 0.31 | 4.4 | 4.60E+12 | 1.30E+03 |
| Example | 15 | 0.027 | 0.024 | 0.29 | 4.3 | 1.12E+12 | 1.28E+03 |
| Example | 16 | 0.024 | 0.025 | 0.31 | 4.3 | 3.52E+12 | 1.17E+03 |
| Comparative | 17 | Without Z | | 0.30 | 4.4 | 3.43E+12 | 1.31E+02 |
| Example | | (Mo added) | | | | | |
| Comparative | 18 | Without Z | | 0.31 | 4.5 | 3.36E+12 | 1.22E+02 |
| Example | | (Y added) | | | | | |
| Comparative | 19 | Without Z | | 0.27 | 4.4 | 2.06E+12 | 9.00E+01 |
| Example | | (Dy added) | | | | | |
| Comparative | 7 | Without Z | | 0.28 | 4.3 | 5.52E+10 | 7.61E+02 |
| Example | | | | | | | |

As shown in Table 2, Sample Nos. 11 to 17, in which the composition of the perovskite-type compound contained in the main phase grains was within a predetermined range and Zm was larger than Zs, exhibited satisfactory high-temperature resistivity and reliability. In contrast, Sample Nos. 17 to 19, in which an element other than Z was used instead of Z in Sample No. 3, exhibited deteriorated reliability. Sample No. 7, in which Z was excluded from Sample No. 3, exhibited decreased high-temperature resistivity.

### Experimental Example 3

In Sample No. 21, the sintering aids and the raw material powder of the oxide of Z were mixed and calcined to obtain a calcined powder. With regard to calcination conditions, the holding temperature was set to 1000° C. and the holding time was set to 2 hours.

Raw material powders other than the sintering aids and the raw material powder of the oxide of Z were mixed with the calcined powder, the resultant mixture was dispersed in pure water, the resultant solution was dried and subjected to a heat treatment, thereby obtaining a dielectric powder. The holding temperature was set to 400° C., and the holding time was set to 2 hours.

As described above, a preparation method in which the sintering aids and the raw material powder of the oxide of Z are mixed and calcined to obtain a calcined powder, and the calcined powder and raw material powders other than the sintering aids and the raw material powder of the oxide of Z are mixed is referred to Preparation Method 2.

In Sample No. 22, the main component raw material powder, and the raw material powder of the oxide of Z were mixed and calcined to obtain a first calcined powder. Calcination conditions were similar to the calcination conditions in Preparation Method 1. Additionally, the sintering aids, and the raw material powder of the oxide of Z were mixed and calcined to obtain a second calcined powder. Calcination conditions were similar to the calcination conditions in Preparation Method 2.

Raw material powders other than the main component raw material powder, the sintering aids, and the raw material powder of the oxide of Z were mixed with the first calcined powder and the second calcined powder, the resultant mixture was dispersed in pure water, and the resultant solution was dried and subjected to a heat treatment to obtain a dielectric powder. The holding temperature was set to 400° C. and the holding time was set to 2 hours. This preparation method is referred to as Preparation Method 3.

In Sample No. 22, a relationship of Zm=Zs was satisfied. In Sample No. 23, a relationship of Zm>Zs was satisfied.

Sample Nos. 21 to 23 were obtained in a similar manner as in Sample No. 3 except for the preparation method of the dielectric powders, and the same experiment was performed. The results are shown in Table 3.

TABLE 3

| | | | | Additive | | | Segregation | Segregation |
|---|---|---|---|---|---|---|---|---|
| | | | | Elements | | | Z/(Z + Si) | Z/(Z + Mn) |
| Example/ | | | | Other Than | | | (ratio of | (ratio of |
| Comparative | Sample | Preparation | Perovskite-Type Compound | Z, Ca, Zr, | Type | | number | number |
| Example | No. | Method | (based on number of atoms) | and Ni | of Z | Zm/Zs | of atoms) | of atoms) |
| Example | 3 | Preparation | (Ca_{0.70}Sr_{0.30})(Zr_{0.97}Ti_{0.03}Hf_{0.01})O₃ | Mn, Si | W | 4.1 | 0.0043 | 0.025 |
| | | Method 1 | | | | | | |
| Comparative | 21 | Preparation | (Ca_{0.70}Sr_{0.30})(Zr_{0.97}Ti_{0.03}Hf_{0.01})O₃ | Mn, Si | W | 0.4 | 0.0043 | 0.027 |
| Example | | Method 2 | | | | | | |
| Comparative | 22 | Preparation | (Ca_{0.70}Sr_{0.30})(Zr_{0.97}Ti_{0.03}Hf_{0.01})O₃ | Mn, Si | W | 1.0 | 0.0047 | 0.025 |
| Example | | Method 3 | | | | | | |
| Example | 23 | Preparation | (Ca_{0.70}Sr_{0.30})(Zr_{0.97}Ti_{0.03}Hf_{0.01})O₃ | Mn, Si | W | 1.7 | 0.0046 | 0.024 |
| | | Method 3 | | | | | | |

| | | | | Segregation | | |
|---|---|---|---|---|---|---|
| | | Segregation | Segregation | (Ca + Sr)/ | | |
| | | Z/(Z + Ni) | Mn/(Mn + Si) | (Zr + Ti) | High- | |
| Example/ | | (ratio of | (ratio of | (ratio of | Temperature | |
| Comparative | Sample | number | number | number | Resistivity | MTTF |
| Example | No. | of atoms) | of atoms) | of atoms) | (Ω · m) | (h) |
| Example | 3 | 0.022 | 0.28 | 4.5 | 4.53E+12 | 1.33E+03 |
| Comparative | 21 | 0.022 | 0.30 | 4.5 | 3.90E+12 | 1.65E+02 |
| Example | | | | | | |
| Comparative | 22 | 0.025 | 0.30 | 4.2 | 4.44E+12 | 1.65E+02 |
| Example | | | | | | |
| Example | 23 | 0.024 | 0.31 | 4.6 | 4.44E+12 | 1.45E+03 |

As shown in Table 3, Sample No. 23, in which the composition of the perovskite-type compound contained in the main phase grains was within a predetermined range and Zm was larger than Zs, exhibited satisfactory high-temperature resistivity and reliability. In contrast, Sample No. 21, in which the content ratio of Z in the main phase grains was smaller than the content ratio of Z in the segregation, and Sample No. 22, in which the content ratio of Z in the main phase grains was equal to the content ratio of Z in the segregation, exhibited deteriorated reliability.

### Experimental Example 4

Sample Nos. 31 to 34 were obtained by changing Zm/Zs within a range of 1.1 or more and not more than 10 by changing the amount of the raw material powder of mainly the W oxide, which was added, from Sample No. 3, and the same experiment was performed. The results are shown in Table 4.

TABLE 4

| | | | | Additive | | | Segregation | Segregation |
|---|---|---|---|---|---|---|---|---|
| | | | | Elements | | | Z/(Z + Si) | Z/(Z + Mn) |
| Example/ | | | | Other Than | | | (ratio of | (ratio of |
| Comparative | Sample | Preparation | Perovskite-Type Compound | Z, Ca, Zr, | Type | | number | number |
| Example | No. | Method | (based on number of atoms) | and Ni | of Z | Zm/Zs | of atoms) | of atoms) |
| Example | 31 | Preparation | (Ca_{0.70}Sr_{0.30})(Zr_{0.97}Ti_{0.03}Hf_{0.01})O₃ | Mn, Si | W | 1.1 | 0.0045 | 0.027 |
| | | Method 1 | | | | | | |
| Example | 32 | Preparation | (Ca_{0.70}Sr_{0.30})(Zr_{0.97}Ti_{0.03}Hf_{0.01})O₃ | Mn, Si | W | 1.6 | 0.0047 | 0.023 |
| | | Method 1 | | | | | | |
| Example | 3 | Preparation | (Ca_{0.70}Sr_{0.30})(Zr_{0.97}Ti_{0.03}Hf_{0.01})O₃ | Mn, Si | W | 4.2 | 0.0045 | 0.026 |
| | | Method 1 | | | | | | |
| Example | 33 | Preparation | (Ca_{0.70}Sr_{0.30})(Zr_{0.97}Ti_{0.03}Hf_{0.01})O₃ | Mn, Si | W | 7.4 | 0.0047 | 0.024 |
| | | Method 1 | | | | | | |
| Example | 34 | Preparation | (Ca_{0.70}Sr_{0.30})(Zr_{0.97}Ti_{0.03}Hf_{0.01})O₃ | Mn, Si | W | 9.8 | 0.0044 | 0.025 |
| | | Method 1 | | | | | | |

| | | | | Segregation | | |
|---|---|---|---|---|---|---|
| | | Segregation | Segregation | (Ca + Sr)/ | | |
| | | Z/(Z + Ni) | Mn/(Mn + Si) | (Zr + Ti) | High- | |
| Example/ | | (ratio of | (ratio of | (ratio of | Temperature | |
| Comparative | Sample | number | number | number | Resistivity | MTTF |
| Example | No. | of atoms) | of atoms) | of atoms) | (Ω · m) | (h) |
| Example | 31 | 0.025 | 0.31 | 4.5 | 3.19E+12 | 2.89E+02 |
| Example | 32 | 0.026 | 0.30 | 4.6 | 3.97E+12 | 1.35E+03 |
| Example | 3 | 0.027 | 0.29 | 4.3 | 2.97E+12 | 1.33E+03 |
| Example | 33 | 0.026 | 0.29 | 4.6 | 1.29E+12 | 1.50E+03 |
| Example | 34 | 0.022 | 0.28 | 4.2 | 2.28E+12 | 4.71E+02 |

As shown in Table 4, in a case where the composition of the perovskite-type compound contained in the main phase grains is within a predetermined range, and Zm is larger than Zs, the high-temperature resistivity and the reliability were satisfactory.

### Experimental Example 5

Sample Nos. 41 to 44 were obtained by changing Z/(Z+Si) by mainly changing the composition of the sintering aids, the amount of the sintering aids added, and/or the amount of the raw material powder of SiO₂ added as a powder of an oxide of an additive element from Sample No. 3, and the same experiment was performed. The results are shown in Table 5.

Sample Nos. 51 to 54 were obtained by changing Z/(Z+Mn) by mainly changing the composition of the sintering aids, the amount of the sintering aids added, and/or the amount of the raw material powder of the Mn oxide added as a powder of an oxide of an additive element from Sample No. 3, and the same experiment was performed. The results are shown in Table 6.

Sample Nos. 61 to 64 were obtained by changing Mn/(Mn+Si) by mainly changing the composition of the sintering aids, the amount of the sintering aids, and/or the amount of various raw material powders, such as the raw material powder of Mn oxide added as an oxide powder of an additive element, from Sample No. 3, and the same experiment was performed. The results are shown in Table 7.

Sample Nos. 71 to 75 were obtained by changing Z/(Z+Ni) by mainly changing the amount of the raw material powder of NiO, which was added, from Sample No. 3, and the same experiment was performed. In Sample No. 71, the NiO powder was not added. The results are shown in Table 8.

Sample Nos. 81 to 84 were obtained by changing (Ca+Sr)/(Zr+Ti) by mainly changing the amount of the raw material powder of the Zr oxide added, and/or the amount of the raw material powder of the Ca oxide added from Sample No. 3, and the same experiment was performed. The results are shown in Table 9.

TABLE 5

| | | | | Additive | | | Segregation | Segregation |
|---|---|---|---|---|---|---|---|---|
| | | | | Elements | | | Z/(Z + Si) | Z/(Z + Mn) |
| Example/ | | | | Other Than | | | (ratio of | (ratio of |
| Comparative | Sample | Preparation | Perovskite-Type Compound | Z, Ca, Zr, | Type | | number | number |
| Example | No. | Method | (based on number of atoms) | and Ni | of Z | Zm/Zs | of atoms) | of atoms) |
| Example | 41 | Preparation | (Ca_{0.70}Sr_{0.30})(Zr_{0.97}Ti_{0.03}Hf_{0.01})O₃ | Mn, Si | W | 4.6 | 0.0001 | 0.024 |
| | | Method 1 | | | | | | |
| Example | 42 | Preparation | (Ca_{0.70}Sr_{0.30})(Zr_{0.97}Ti_{0.03}Hf_{0.01})O₃ | Mn, Si | W | 4.1 | 0.0003 | 0.026 |
| | | Method 1 | | | | | | |
| Example | 3 | Preparation | (Ca_{0.70}Sr_{0.30})(Zr_{0.97}Ti_{0.03}Hf_{0.01})O₃ | Mn, Si | W | 4.2 | 0.0045 | 0.026 |
| | | Method 1 | | | | | | |
| Example | 43 | Preparation | (Ca_{0.70}Sr_{0.30})(Zr_{0.97}Ti_{0.03}Hf_{0.01})O₃ | Mn, Si | W | 4.0 | 0.0079 | 0.022 |
| | | Method 1 | | | | | | |
| Example | 44 | Preparation | (Ca_{0.70}Sr_{0.30})(Zr_{0.97}Ti_{0.03}Hf_{0.01})O₃ | Mn, Si | W | 3.9 | 0.0110 | 0.023 |
| | | Method 1 | | | | | | |

| | | | | Segregation | | |
|---|---|---|---|---|---|---|
| | | Segregation | Segregation | (Ca + Sr)/ | | |
| | | Z/(Z + Ni) | Mn/(Mn + Si) | (Zr + Ti) | High- | |
| Example/ | | (ratio of | (ratio of | (ratio of | Temperature | |
| Comparative | Sample | number | number | number | Resistivity | MTTF |
| Example | No. | of atoms) | of atoms) | of atoms) | (Ω · m) | (h) |
| Example | 41 | 0.027 | 0.30 | 4.2 | 2.91E+12 | 4.54E+02 |
| Example | 42 | 0.027 | 0.28 | 4.3 | 2.40E+12 | 1.15E+03 |
| Example | 3 | 0.022 | 0.31 | 4.4 | 4.99E+12 | 1.33E+03 |
| Example | 43 | 0.022 | 0.27 | 4.5 | 1.54E+12 | 1.35E+03 |
| Example | 44 | 0.024 | 0.30 | 4.3 | 4.39E+12 | 3.90E+02 |

TABLE 6

| | | | | Additive | | | Segregation | Segregation |
|---|---|---|---|---|---|---|---|---|
| | | | | Elements | | | Z/(Z + Si) | Z/(Z + Mn) |
| Example/ | | | | Other Than | | | (ratio of | (ratio of |
| Comparative | Sample | Preparation | Perovskite-Type Compound | Z, Ca, Zr, | Type | | number | number |
| Example | No. | Method | (based on number of atoms) | and Ni | of Z | Zm/Zs | of atoms) | of atoms) |
| Example | 51 | Preparation | (Ca_{0.70}Sr_{0.30})(Zr_{0.97}Ti_{0.03}Hf_{0.01})O₃ | Mn, Si | W | 4.3 | 0.0044 | 0.001 |
| | | Method 1 | | | | | | |
| Example | 52 | Preparation | (Ca_{0.70}Sr_{0.30})(Zr_{0.97}Ti_{0.03}Hf_{0.01})O₃ | Mn, Si | W | 4.7 | 0.0043 | 0.004 |
| | | Method 1 | | | | | | |
| Example | 3 | Preparation | (Ca_{0.70}Sr_{0.30})(Zr_{0.97}Ti_{0.03}Hf_{0.01})O₃ | Mn, Si | W | 4.2 | 0.0045 | 0.025 |
| | | Method 1 | | | | | | |
| Example | 53 | Preparation | (Ca_{0.70}Sr_{0.30})(Zr_{0.97}Ti_{0.03}Hf_{0.01})O₃ | Mn, Si | W | 4.0 | 0.0043 | 0.048 |
| | | Method 1 | | | | | | |
| Example | 54 | Preparation | (Ca_{0.70}Sr_{0.30})(Zr_{0.97}Ti_{0.03}Hf_{0.01})O₃ | Mn, Si | W | 4.2 | 0.0043 | 0.061 |
| | | Method 1 | | | | | | |

| | | | | Segregation | | |
|---|---|---|---|---|---|---|
| | | Segregation | Segregation | (Ca + Sr)/ | | |
| | | Z/(Z + Ni) | Mn/(Mn + Si) | (Zr + Ti) | High- | |
| Example/ | | (ratio of | (ratio of | (ratio of | Temperature | |
| Comparative | Sample | number | number | number | Resistivity | MTTF |
| Example | No. | of atoms) | of atoms) | of atoms) | (Ω · m) | (h) |
| Example | 51 | 0.026 | 0.28 | 4.3 | 4.82E+12 | 2.17E+02 |
| Example | 52 | 0.024 | 0.27 | 4.3 | 3.86E+12 | 1.14E+03 |
| Example | 3 | 0.026 | 0.29 | 4.3 | 1.58E+12 | 1.33E+03 |
| Example | 53 | 0.022 | 0.31 | 4.2 | 3.52E+12 | 1.43E+03 |
| Example | 54 | 0.023 | 0.28 | 4.6 | 3.02E+12 | 2.21E+02 |

TABLE 7

| | | | | Additive | | | Segregation | Segregation |
|---|---|---|---|---|---|---|---|---|
| | | | | Elements | | | Z/(Z + Si) | Z/(Z + Mn) |
| Example/ | | | | Other Than | | | (ratio of | (ratio of |
| Comparative | Sample | Preparation | Perovskite-Type Compound | Z, Ca, Zr, | Type | | number | number |
| Example | No. | Method | (based on number of atoms) | and Ni | of Z | Zm/Zs | of atoms) | of atoms) |
| Example | 61 | Preparation | (Ca_{0.70}Sr_{0.30})(Zr_{0.97}Ti_{0.03}Hf_{0.01})O₃ | Mn, Si | W | 4.5 | 0.0039 | 0.030 |
| | | Method 1 | | | | | | |
| Example | 62 | Preparation | (Ca_{0.70}Sr_{0.30})(Zr_{0.97}Ti_{0.03}Hf_{0.01})O₃ | Mn, Si | W | 3.8 | 0.0037 | 0.031 |
| | | Method 1 | | | | | | |
| Example | 3 | Preparation | (Ca_{0.70}Sr_{0.30})(Zr_{0.97}Ti_{0.03}Hf_{0.01})O₃ | Mn, Si | W | 4.2 | 0.0045 | 0.025 |
| | | Method 1 | | | | | | |
| Example | 63 | Preparation | (Ca_{0.70}Sr_{0.30})(Zr_{0.97}Ti_{0.03}Hf_{0.01})O₃ | Mn, Si | W | 4.2 | 0.0041 | 0.029 |
| | | Method 1 | | | | | | |
| Example | 64 | Preparation | (Ca_{0.70}Sr_{0.30})(Zr_{0.97}Ti_{0.03}Hf_{0.01})O₃ | Mn, Si | W | 4.4 | 0.0042 | 0.023 |
| | | Method 1 | | | | | | |

| | | | | Segregation | | |
|---|---|---|---|---|---|---|
| | | Segregation | Segregation | (Ca + Sr)/ | | |
| | | Z/(Z + Ni) | Mn/(Mn + Si) | (Zr + Ti) | High- | |
| Example/ | | (ratio of | (ratio of | (ratio of | Temperature | |
| Comparative | Sample | number | number | number | Resistivity | MTTF |
| Example | No. | of atoms) | of atoms) | of atoms) | (Ω · m) | (h) |
| Example | 61 | 0.027 | 0.005 | 4.5 | 2.21E+10 | 2.35E+02 |
| Example | 62 | 0.026 | 0.010 | 4.6 | 1.37E+12 | 1.48E+03 |
| Example | 3 | 0.022 | 0.290 | 4.2 | 1.31E+12 | 1.33E+03 |
| Example | 63 | 0.024 | 0.470 | 4.2 | 2.23E+12 | 1.45E+03 |
| Example | 64 | 0.027 | 0.870 | 4.6 | 9.51E+10 | 3.28E+02 |

TABLE 8

| | | | | Additive | | | Segregation | Segregation |
|---|---|---|---|---|---|---|---|---|
| | | | | Elements | | | Z/(Z + Si) | Z/(Z + Mn) |
| Example/ | | | | Other Than | | | (ratio of | (ratio of |
| Comparative | Sample | Preparation | Perovskite-Type Compound | Z, Ca, Zr, | Type | | number | number |
| Example | No. | Method | (based on number of atoms) | and Ni | of Z | Zm/Zs | of atoms) | of atoms) |
| Example | 71 | Preparation | (Ca_{0.70}Sr_{0.30})(Zr_{0.97}Ti_{0.03}Hf_{0.01})O₃ | Mn, Si | W | 4.3 | 0.0041 | 0.030 |
| | | Method 1 | | | | | | |
| Example | 72 | Preparation | (Ca_{0.70}Sr_{0.30})(Zr_{0.97}Ti_{0.03}Hf_{0.01})O₃ | Mn, Si | W | 4.1 | 0.0046 | 0.025 |
| | | Method 1 | | | | | | |
| Example | 73 | Preparation | (Ca_{0.70}Sr_{0.30})(Zr_{0.97}Ti_{0.03}Hf_{0.01})O₃ | Mn, Si | W | 4.2 | 0.0044 | 0.023 |
| | | Method 1 | | | | | | |
| Example | 3 | Preparation | (Ca_{0.70}Sr_{0.30})(Zr_{0.97}Ti_{0.03}Hf_{0.01})O₃ | Mn, Si | W | 4.2 | 0.0045 | 0.025 |
| | | Method 1 | | | | | | |
| Example | 74 | Preparation | (Ca_{0.70}Sr_{0.30})(Zr_{0.97}Ti_{0.03}Hf_{0.01})O₃ | Mn, Si | W | 4.0 | 0.0040 | 0.031 |
| | | Method 1 | | | | | | |
| Example | 75 | Preparation | (Ca_{0.70}Sr_{0.30})(Zr_{0.97}Ti_{0.03}Hf_{0.01})O₃ | Mn, Si | W | 4.5 | 0.0045 | 0.027 |
| | | Method 1 | | | | | | |

| | | | | Segregation | | |
|---|---|---|---|---|---|---|
| | | Segregation | Segregation | (Ca + Sr)/ | | |
| | | Z/(Z + Ni) | Mn/(Mn + Si) | (Zr + Ti) | High- | |
| Example/ | | (ratio of | (ratio of | (ratio of | Temperature | |
| Comparative | Sample | number | number | number | Resistivity | MTTF |
| Example | No. | of atoms) | of atoms) | of atoms) | (Ω · m) | (h) |
| Example | 71 | 0.000 | 0.34 | 4.3 | 2.91E+12 | 2.97E+02 |
| Example | 72 | 0.001 | 0.31 | 4.4 | 4.29E+12 | 1.26E+03 |
| Example | 73 | 0.012 | 0.29 | 4.4 | 2.48E+12 | 1.43E+03 |
| Example | 3 | 0.026 | 0.29 | 4.3 | 4.87E+12 | 1.33E+03 |
| Example | 74 | 0.056 | 0.32 | 4.3 | 1.92E+12 | 1.41E+03 |
| Example | 75 | 0.082 | 0.34 | 4.5 | 4.23E+12 | 3.36E+02 |

TABLE 9

| | | | | Additive | | | Segregation | Segregation |
|---|---|---|---|---|---|---|---|---|
| | | | | Elements | | | Z/(Z + Si) | Z/(Z + Mn) |
| Example/ | | | | Other Than | | | (ratio of | (ratio of |
| Comparative | Sample | Preparation | Perovskite-Type Compound | Z, Ca, Zr, | Type | | number | number |
| Example | No. | Method | (based on number of atoms) | and Ni | of Z | Zm/Zs | of atoms) | of atoms) |
| Example | 81 | Preparation | (Ca_{0.70}Sr_{0.30})(Zr_{0.97}Ti_{0.03}Hf_{0.01})O₃ | Mn, Si | W | 4.2 | 0.0039 | 0.025 |
| | | Method 1 | | | | | | |
| Example | 82 | Preparation | (Ca_{0.70}Sr_{0.30})(Zr_{0.97}Ti_{0.03}Hf_{0.01})O₃ | Mn, Si | W | 4.5 | 0.0044 | 0.029 |
| | | Method 1 | | | | | | |
| Example | 3 | Preparation | (Ca_{0.70}Sr_{0.30})(Zr_{0.97}Ti_{0.03}Hf_{0.01})O₃ | Mn, Si | W | 4.2 | 0.0045 | 0.025 |
| | | Method 1 | | | | | | |
| Example | 83 | Preparation | (Ca_{0.70}Sr_{0.30})(Zr_{0.97}Ti_{0.03}Hf_{0.01})O₃ | Mn, Si | W | 3.9 | 0.0038 | 0.022 |
| | | Method 1 | | | | | | |
| Example | 84 | Preparation | (Ca_{0.70}Sr_{0.30})(Zr_{0.97}Ti_{0.03}Hf_{0.01})O₃ | Mn, Si | W | 3.7 | 0.0046 | 0.025 |
| | | Method 1 | | | | | | |

| | | | | Segregation | | |
|---|---|---|---|---|---|---|
| | | Segregation | Segregation | (Ca + Sr)/ | | |
| | | Z/(Z + Ni) | Mn/(Mn + Si) | (Zr + Ti) | High- | |
| Example/ | | (ratio of | (ratio of | (ratio of | Temperature | |
| Comparative | Sample | number | number | number | Resistivity | MTTF |
| Example | No. | of atoms) | of atoms) | of atoms) | (Ω · m) | (h) |
| Example | 81 | 0.022 | 0.26 | 0.6 | 8.30E+10 | 3.07E+02 |
| Example | 82 | 0.024 | 0.30 | 1.2 | 3.98E+12 | 1.32E+03 |
| Example | 3 | 0.026 | 0.29 | 4.4 | 3.92E+12 | 1.33E+03 |
| Example | 83 | 0.028 | 0.30 | 7.7 | 2.86E+12 | 1.26E+03 |
| Example | 84 | 0.030 | 0.34 | 9.5 | 2.99E+10 | 4.85E+02 |

As shown in Tables 5 to 9, even when changing various parameters relating to the segregation, in a case where the composition of the perovskite-type compound contained in the main phase grains is within a predetermined range, and Zm is larger than Zs, the high-temperature resistivity and the reliability were satisfactory.

### REFERENCE SIGNS LIST

1 multilayer ceramic capacitor
2 dielectric layer
3 inner electrode layer
4 outer electrode
10 element body
12 segregation

What is claimed is:

1. A multilayer ceramic electronic device, comprising:
an element body including a dielectric layer and an inner electrode layer laminated on the dielectric layer,
wherein the dielectric layer includes main phase grains,
the element body includes a segregation,
the main phase grains contain a perovskite-type compound expressed by a composition formula of (Ca₁₋ₓ₋ₚSrₓBaₚ)ₘ(Zr_{1-y-z}Ti_{y}Hf_{z})O₃ as a main component based on the number of atoms,
relationships of 0≤x≤1.0, 0≤p<1.0, 0.9≤m≤1.1, 0≤y≤0.20, and 0≤z<1.0 are satisfied,
the main phase grains further contain an oxide of Z,
Z comprises at least one selected from the group consisting of V, Nb, Ta, and W,
the segregation contains at least L, Mn, Si, and O,
L comprises at least one selected from the group consisting of Ca and Sr, and
a content ratio of Z in the main phase grains is larger than a content ratio of Z in the segregation.

2. The multilayer ceramic electronic device according to claim 1, wherein relationships of 0≤x<0.80, 0≤p<0.40, 0.9<m<1.1, 0≤y≤0.10, and 0≤z<0.20 are satisfied.

3. The multilayer ceramic electronic device according to claim 1, wherein relationships of 0≤x<0.40, p=0, 0.9<m<1.1, 0.01<y≤0.10, and 0≤z<0.20 are satisfied.

4. The multilayer ceramic electronic device according to claim 1, wherein a relationship of 1.5<Zm/Zs<7.5 is satisfied where a content ratio of Z contained in the main phase grains to the total content of all element contained in the main phase grains is set as Zm based on the number of atoms, and a content ratio of Z contained in the segregation to the total content of all element contained in the segregation is set as Zs based on the number of atoms.

5. The multilayer ceramic electronic device according to claim 1, wherein a value obtained by dividing a content of Z by the total content of Z and Si is 0.0002 or more and less than 0.0080 based on the number of atoms in the segregation.

6. The multilayer ceramic electronic device according to claim 1, wherein a value obtained by dividing a content of Z by the total content of Z and Mn is 0.003 or more and less than 0.080 based on the number of atoms in the segregation.

7. The multilayer ceramic electronic device according to claim 1, wherein a value obtained by dividing a content of Mn by the total content of Si and Mn is 0.02 or more and less than 0.50 based on the number of atoms in the segregation.

8. The multilayer ceramic electronic device according to claim 1, wherein a value obtained by dividing a content of Z by the total content of Z and Ni is more than 0 and less than 0.060 based on the number of atoms in the segregation.

9. The multilayer ceramic electronic device according to claim 1, wherein a value obtained by dividing the total content of Ca and Sr by the total content of Zr and Ti is 1.0 or more and 8.0 or less based on the number of atoms in the segregation.

10. The multilayer ceramic electronic device according to claim 1, wherein the segregation contains oxides of at least one selected from the group consisting of Al, Mg, Li, B, and P.

11. The multilayer ceramic electronic device according to claim 1, wherein a main component of a conductive material contained in the inner electrode layer is Ni or a Ni-based alloy.
